(19) United States
(12) Patent Application Publication
(10) Pub. No.: US 2014/0087888 A1
(43) Pub. Date: Mar. 27, 2014

(54) Gaming Machines And Gaming Systems Having A Personal Storage Alcove

(71) Applicant: WMS GAMING INC., Waukegan, IL (US)

(72) Inventors: Christopher W. Chudek, Evanston, IL (US); Scot W. Salzman, Buffalo Grove, IL (US)

(73) Assignee: WMS Gaming Inc., Waukegan, IL (US)

(21) Appl. No.: 13/628,535

(22) Filed: Sep. 27, 2012

(51) Int. Cl. A63F 13/08

(52) U.S. Cl. 463/46

(57) ABSTRACT

A gaming machine includes one or more display devices configured to display the game, a cabinet housing the one or more display devices, and an alcove defined by a portion of an exterior surface of the cabinet. The alcove is configured to store one or more personal items and permit egress of a fluid from within the alcove.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus and methods and, more particularly, to a gaming terminal and a gaming system having a personal storage alcove.

### BACKGROUND OF THE INVENTION

Gaming terminals are often provided on a stand when deployed in a casino or other gaming environment. In many instances, the footprint dimensions of a stand may not be exactly the same as the footprint dimensions of a gaming terminal. As a result, there may be an unused, open space on the stand adjacent to the gaming terminal. Players have taken advantage of this open space on the stand by using it as a surface to place beverages, ashtrays, mobile phones, wallets, keys, purses, and other personal items. Significantly, however, placing such personal items out in the open presents a number security and privacy issues. For example, when personal items sit out in the open to the side of a gaming terminal, the personal items may be easily stolen by a thief reaching from behind the gaming terminal or a lateral position outside of the player's periphery vision. Additionally, for example, when a player's mobile phone is sitting out in the open to the side of a gaming terminal, other people may view messages appearing on the player's mobile phone without the player's knowledge or consent.

### SUMMARY OF THE INVENTION

According to one aspect of the present invention, a gaming machine includes one or more display devices configured to display the game, a cabinet housing the one or more display devices, and an alcove defined by a portion of an exterior surface of the cabinet. The alcove is configured to store one or more personal items and permit egress of a fluid from within the alcove.

According to another aspect of the present invention, a gaming system includes one or more display devices configured to display a game, a cabinet housing the one or more display devices, and an alcove defined by a portion of an exterior surface of the cabinet. The alcove is configured to store one or more personal items. The alcove includes a bottom surface, a top surface, a back surface and one or more side surfaces. The bottom surface, the top surface and the one or more side surfaces define an opening on a front side of the alcove.

According to another aspect of the present invention, a gaming system includes one or more display devices configured to display a game and a cabinet housing the one or more display devices. A portion of an exterior surface of the cabinet defines an alcove. The system further includes one or more sensors configured to measure an amount of a contents in a beverage container stored in the alcove and generate a signal indicative of the amount of the contents. The system also includes one or more processors in communication with the one or more sensors. The one or more processors are operable to receive the signal from the one or more sensors, determine whether the measured amount of contents is below a threshold amount, and, if it is determined that the measured amount is below the threshold amount, generate an alert signal indicating that the measured amount is below the threshold amount.

According to still another aspect of the present invention, a gaming system includes a first cabinet housing electronic components for conducting a first game and a second cabinet housing electronic components for conducting a second game. The second cabinet is positioned adjacent to the first cabinet. The gaming system further includes an alcove configured to store a personal item and facilitate egress of a liquid from the alcove. The alcove is defined by a first portion of the first cabinet and a second portion of the second cabinet.

According to another aspect of the present invention, a method for monitoring the contents of a beverage container within an alcove of a gaming terminal includes measuring, using one or more sensors, an amount of contents within the beverage container, generating a measurement signal that is indicative of the measured amount of contents, and communicating the measurement signal from the one or more sensors to one or more processors. The method further includes processing, via at least one of the one or more processors, the measurement signal, and determining whether to generate an alert signal based on the processing to provide a notification that the contents of the beverage container are low.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming terminal according to an embodiment of the present concepts.

FIG. 2 is a schematic view of a gaming system according to an embodiment of the present concepts.

FIG. 3 is an image of an exemplary basic-game screen of a wagering game displayed on a gaming terminal, according to an embodiment of the present concepts.

FIG. 4A is a perspective view of a gaming terminal according to another exemplary embodiment of the present concepts.

FIG. 4B is a front view of the gaming terminal of FIG. 4A.

FIG. 4C is a sectional view through the line 4C-4C of the gaming terminal shown in FIG. 4B.

FIG. 4D is a sectional view through the line 4D-4D of the gaming terminal shown in FIG. 4B.

FIG. 5A is a perspective view of a gaming terminal according to another exemplary embodiment of the present concepts.

FIG. 5B is a sectional view through the line 5B-5B of the gaming terminal shown in FIG. 5A.

FIG. 5C is a sectional view through the line 5C-5C of the gaming terminal shown in FIG. 5A.

FIG. 6 is a flowchart for an algorithm that corresponds to instructions executed by a controller in accord with at least some aspects of the disclosed concepts.

FIG. 7 is a flowchart for an algorithm that corresponds to instructions executed by a controller in accord with at least some aspects of the disclosed concepts.

FIG. 8 is a perspective view of a first gaming terminal and a second gaming terminal according to another exemplary embodiment of the present concepts.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

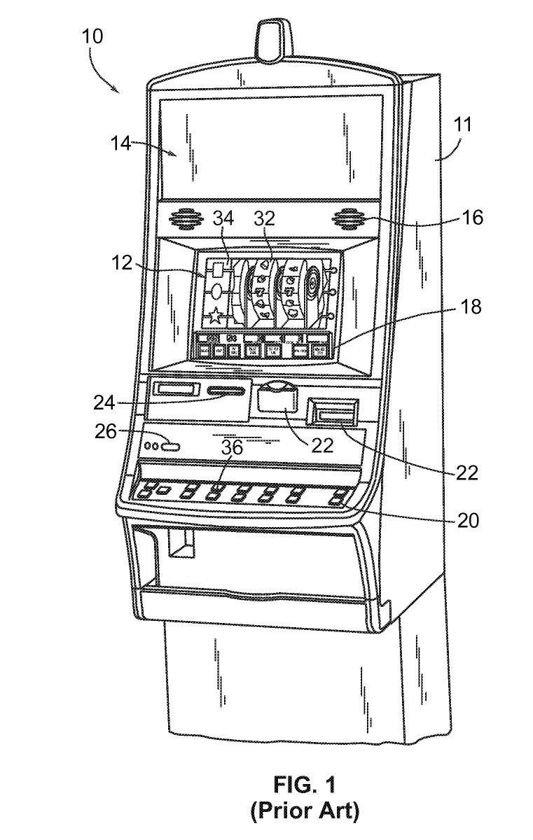

Referring to FIG. 1, there is shown a gaming terminal 10 similar to those used in gaming establishments, such as casinos. With regard to the present invention, the gaming terminal 10 may be any type of gaming terminal and may have varying structures and methods of operation. For example, in some aspects, the gaming terminal 10 is an electromechanical gaming terminal configured to play mechanical slots, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models as shown, handheld mobile units, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433, titled “Reel Spinning Slot Machine With Superimposed Video Image,” U.S. Patent Application Publication Nos. US2010/0069160, titled “Handheld Wagering Game Machine And Docking Unit,” and US2010/0234099, titled “Wagering Game System With Docking Stations” which are incorporated herein by reference in their entireties.

The gaming terminal 10 illustrated in FIG. 1 comprises a cabinet 11 that may house various input devices, output devices, and input/output devices. By way of example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming terminal 10. The gaming terminal 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

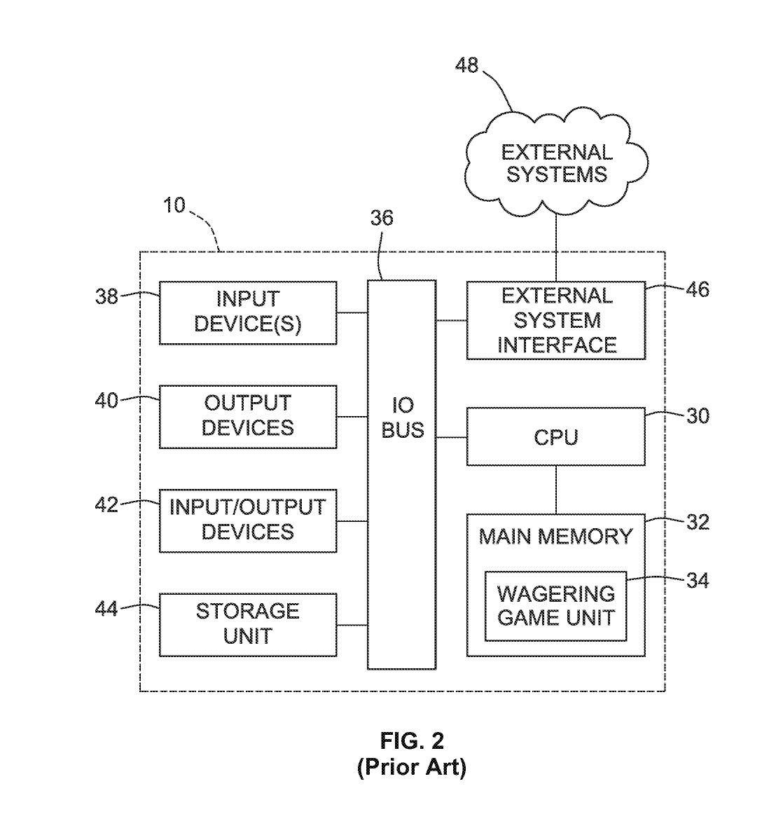

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by Intel and AMD. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

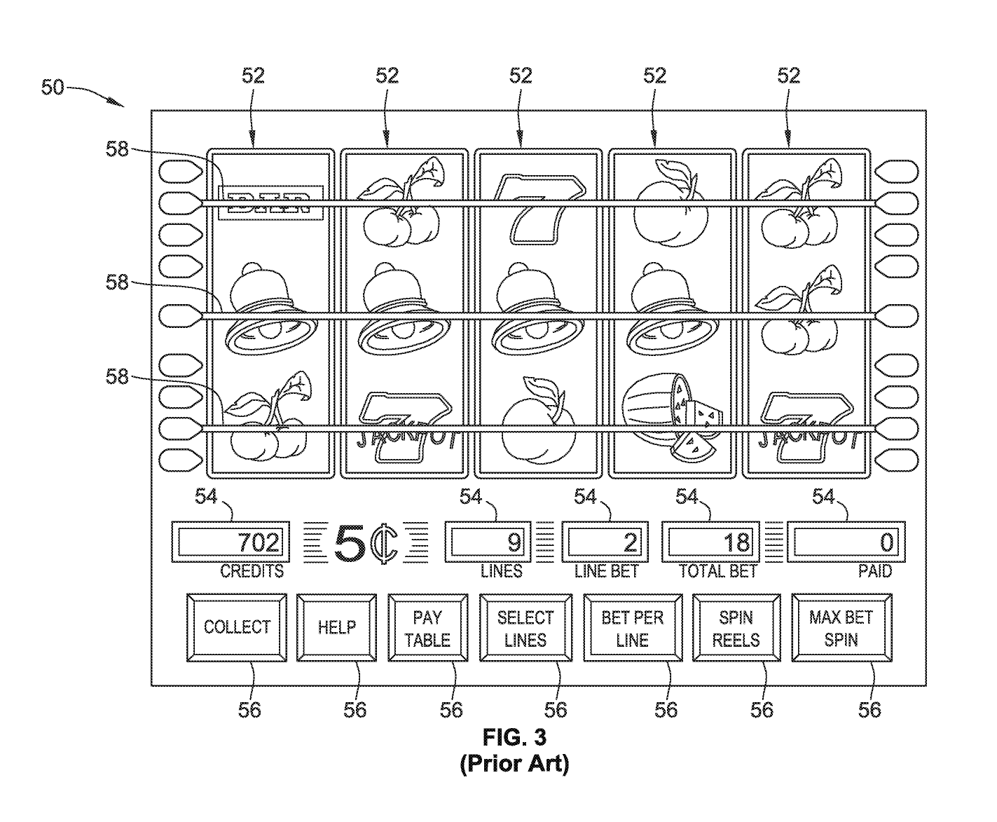

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving an input indicative of a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12, other display device, or other output device (e.g., speakers, lights, communication device, etc.) to change from a first state to at least a second state, wherein the second state of the primary display 12 comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

Gaming terminals (e.g., the gaming terminal 10) are often provided on a stand when deployed in a casino or other gaming environment. In many instances, the footprint dimensions of a stand may not be exactly the same as the footprint dimensions of a gaming terminal. As a result, there may be an unused, open space on the stand adjacent to the gaming terminal. Players have taken advantage of this open space on the stand by using it as a surface to place beverages, ashtrays, mobile phones, wallets, keys, purses, and other personal items. Significantly, however, placing such personal items out in the open presents a number of security and privacy issues. For example, when personal items sit out in the open to the side of a gaming terminal, the personal items may be easily stolen by a thief reaching from behind the gaming terminal or a lateral position outside of the player's periphery vision.

If the footprint dimensions of the gaming terminal are similar to or greater than the footprint dimensions of the stand, it has been found that players often place their personal items on the floor. This presents similar security issues and also exposes the personal items to potentially dirty conditions. Moreover, a beverage placed on the floor at a player's feet is more likely to be accidently spilled by the player. The resulting filth and soiling of the area around a gaming terminal is aesthetically displeasing, dissuading players from playing the gaming terminal and requiring more frequent cleaning service by casino or gaming establishment personnel.

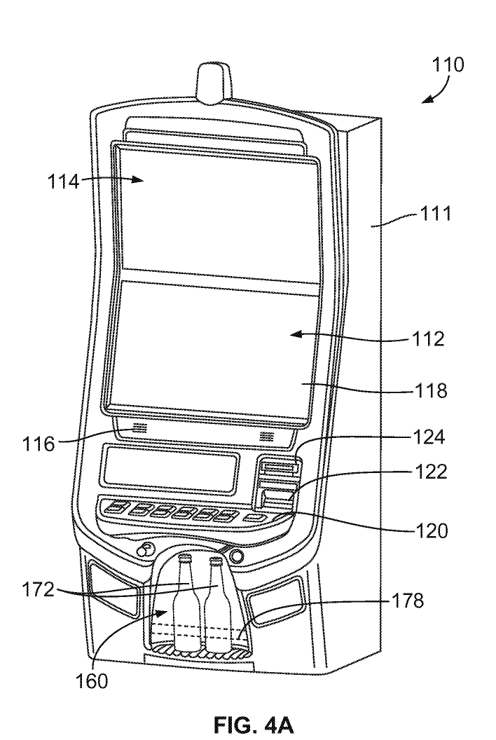

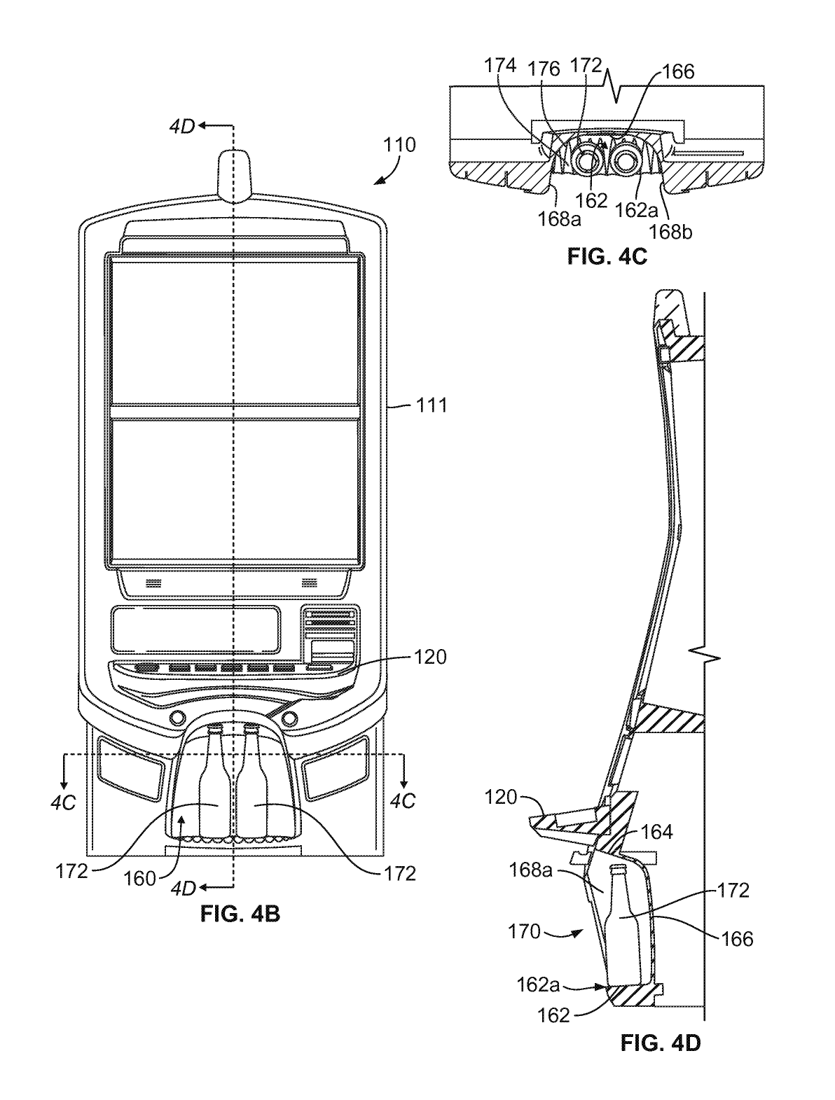

According to aspects of the present disclosure, a gaming terminal includes features configured to provide a conveniently accessible, secure, and clean environment for storage of personal items while playing the gaming terminal. Referring to FIGS. 4A-4B, a gaming terminal 110 in accordance with aspects of the present disclosure is illustrated. The gaming terminal 110 can include features similar to the features described above with respect to the gaming terminal 10 illustrated in FIGS. 1-2. For example, the gaming terminal 110 can include a cabinet 111, a primary display 112, a secondary display 114, one or more audio speakers 116, a touch screen(s) 118, a button panel(s) 120 including one or more buttons, a bill validator(s) 122, an information reader/writer(s) 124, and/or a player-accessible port(s).

While, in general, a cabinet for a gaming terminal is configured to house the components of the gaming terminal, the cabinet 111 of the gaming terminal 110 is advantageously configured to also store one or more personal items of a player playing a game on the gaming terminal 110. In particular, the gaming terminal 110 includes an alcove 160 defined by a portion of an exterior surface of the cabinet 111. To facilitate a description of the alcove 160, FIG. 4C shows a first sectional view of the gaming terminal 110 through the line 4C-4C (shown in FIG. 4B) and FIG. 4D shows a second sectional view of the gaming terminal 110 through the line 4D-4D (shown in FIG. 4B). In the exemplary embodiment illustrated in FIGS. 4A-4D, the alcove 160 includes a bottom surface 162, a top surface 164, a back surface 166, a first side surface 168a, and a second side surface 168b. The bottom surface 162, the top surface 164, the first side surface 168a, and the second side surface 168b define an opening 170 on a front side (i.e., a player-proximal side) of the alcove 160. The opening 170 thus provides access to a recessed area of the alcove 160 to allow a player to conveniently store one or more personal items (e.g., a beverage container 172) in a more secure and private manner.

According to some aspects, the alcove 160 can include one or more features for further enhancing security and privacy. For example, as shown in FIG. 4C, the alcove 160 can be configured such that a portion of the first side surface 168a and a portion of the second side surface 168b extend beyond a proximal-most end 162a of the bottom surface 162 (i.e., in a direction from the back surface 166 generally towards the opening 170). With the first side surface 168a and the second side surface 168b extending beyond the bottom surface 162, it is more difficult to see or access the personal item(s) 172 from a lateral position relative to the gaming terminal 110. Yet, access to the personal item(s) 172 from a frontward position, in which a player is mostly likely sitting or standing while playing a game on the gaming terminal 110, is minimally affected. As such, the extension of a portion of the first and second side surfaces 168a,b beyond the proximal-most end 162a of the bottom surface 162 can advantageously provide further enhancements to security and privacy without substantially inhibiting accessibility for the player.

As shown, for example in FIG. 4D, the portions of the first side surface 168a and the second side surface 168b extending proximally beyond the bottom surface 162 have a tapered shape from a position near the top surface 164 towards the proximal-most end 162a of the bottom surface 162; however, it is contemplated that, according to additional or alternative embodiments, the portions of the first side surface 168a and the second side surface 168b extending beyond the bottom surface 162 can have profile shapes other than the illustrated tapering profile shape.

According to some aspects, the alcove 160 can also include one or more features to facilitate ingress and egress of a personal item in and out of the alcove 160. For example, as shown in FIG. 4D, the top surface 164 can be angled upwards (e.g., generally in a direction from the bottom surface 162 towards the top surface 164) from the back surface 166 to the opening 170 of the alcove 160. Typically, a player is either seated or standing in front of the gaming terminal 110 such that the player reaches downwards to access the recessed area of the alcove 160. Accordingly, a player will have a tendency to place a personal item (e.g., the beverage containers 172) in the alcove 160 with a general downward motion and retrieve a personal item from the alcove 160 with a generally upward motion. Angling the top surface 164 in the manner described can provide additional space to accommodate the natural motion of a player's hand(s) as the player places or retrieves a personal item in the alcove 160.

As another example, the first side surface 168a, the back surface 166, and the second side surface 168b can be configured to facilitate ingress and egress of a personal item (e.g., the beverage container 172). In the exemplary embodiment illustrated in FIGS. 4A-4D, for example, the first side surface 168a, the back surface 166, and the second side surface 168b define an interior wall having a concave shape within the alcove 160 to assist in guiding a personal item from a lateral position within the alcove 160 towards a more central position within the alcove 160 as the personal item is placed in the alcove 160. However, it is contemplated that, according to some embodiments, the first side surface 168a, the back surface 166, and the second side surface 168b can define one or more interior walls having other shapes.

According to some aspects, the alcove 160 can also include one or more features to facilitate egress of liquids from within the alcove 160. As the beverage container 172 is being placed in or removed from the alcove 160, some liquid may spill from the beverage container 172 within the alcove 160. Additionally, when a cold beverage is stored in the alcove 160, the warmer air surrounding the beverage container 172 condenses on to the beverage container 172. This condensation may drip from the beverage container 172 onto the bottom surface 162 of the alcove 160. If such liquids were permitted to accumulate within the alcove 160, the player's beverage container 172 would sit in the liquids and likely drip from the beverage container 172 on to the player when removed from the alcove 160.

To facilitate egress of liquids from the alcove 160, the alcove 160 can be configured, for example, so that at least a portion of the opening 170 extends to the bottom surface 162 at or near the proximal-most end 162a of the bottom surface 162. In other words, the alcove 160 can omit a structure (e.g., an upwardly extending lip) at the proximal-most end 162a of the bottom surface 162 that may prevent or substantially inhibit egress of a liquid from the alcove 160 along the bottom surface 162.

Additionally, for example, to facilitate egress of liquids from the alcove 160, the bottom surface 162 can be angled downwards (i.e., generally in a direction from the top surface 164 towards the bottom surface 162) from the back surface 166 to the opening 170 of the alcove 160. The downward angle can be great enough to cause liquids to flow towards the opening 170 but not so great that the beverage container 172 will slide down the bottom surface 162 and out of the alcove 160. According to one non-limiting example, the bottom surface 162 can be configured at an angle of approximately 1 degree to approximately 4 degrees relative to a floor or the stand on which the gaming terminal 110 rests (e.g., relative to a depth dimension that is generally perpendicular to the line 4C-4C and the line 4D-4D). According to another non-limiting example, the bottom surface 162 can be configured at an angle of approximately 2 degrees to approximately 3 degrees relative to the floor or the stand on which the gaming terminal 110 rests.

As another example, the bottom surface 162 can include a plurality of grooves 174 and slats 176 configured to allow the beverage container(s) 172 (or other personal item) to sit on the plurality of slats 176 above liquids that flow and/or accumulate in the plurality of grooves 174. The plurality grooves 174 and the plurality of slats 176 can be provided in a number, size, and/or shape configured to mitigate a risk of the beverage container 172 tipping over within the alcove 160. Additionally, for example, the plurality of slats 176 can be substantially flat so as to provide a substantially flat bottom surface 162 for the beverage container 172 to be placed upon. With the beverage container 172 (or other personal item) located in an elevated position above the liquids within the alcove 160, the amount of liquid on the bottom of the beverage container 172 is reduced and, thus, the likelihood that such liquids will spill on a player is reduced. Moreover, with the beverage container 172 located in the elevated position, the beverage container 172 is less likely to inhibit the egress of liquids from the alcove 160.

It is contemplated that, according to some embodiments, a retention structure 178 optionally can be provided to assist in retaining the beverage container(s) 172 or other personal item within the alcove 160. As shown in FIG. 4A, for example, the restraining structure 178 is spaced upwardly from the bottom surface 162 so as to permit egress of liquids from the alcove 160. A restraining structure 178 may also provide additional security for a personal item located within the alcove 160 as a restraining structure 178 inhibits removal of a personal item from within the alcove 160.

According to some aspects, the alcove 160 can have dimensions that are suitable for storing one or more personal items (e.g., the beverage container(s) 172) in the alcove 160. For example, the alcove 160 can have a height in a range from approximately 7 inches (approximately 178 millimeters) to approximately 10 inches (approximately 254 millimeters), a width in a range from approximately 5 inches (approximately 127 millimeters) to approximately 10 inches (approximately 254 millimeters) and a depth in a range from approximately 2 inches (approximately 51 millimeters) to approximately 4 inches (approximately 102 millimeters). As another example, the alcove 160 can have a height of approximately 9.5 inches (approximately 241 millimeters), a width of approximately 9 inches (approximately 229 millimeters), and depth of approximately 3 inches (approximately 76 millimeters). However, it should be understood that the alcove 160 can have other suitable dimensions and/or that the alcove can have a different shape than the shape of the alcove 160 in the illustrated embodiment of FIGS. 4A-4D.

While the alcove 160 of the gaming terminal 110 illustrated in FIGS. 4A-4D is located in a substantially central location relative to a width (e.g., a dimension generally parallel to the line 4C-4C) and beneath the button panel 120, it is contemplated that, according to some embodiments, the alcove 160 can be provided in other locations on the gaming terminal 110. For example, the alcove 160 can be offset to either side of the gaming terminal 110 and/or the alcove 160 can be located at other locations relative to a height (e.g., a dimension generally parallel to the line 4D-4D). However, locating the alcove 160 beneath the button panel 120 (e.g., as shown in the illustrated, exemplary embodiment) can further enhance security and privacy as the button panel 120 extends proximally relative to the alcove 160, obstructing a view of and access to a personal item in the alcove 160 from positions in which a player is unlikely to be.

As described above, the alcove(s) of the present disclosure (e.g., the alcove 160 of the gaming terminal 110) provide a conveniently accessible, secure, and clean environment for storage of beverages (and other personal items) while playing a gaming terminal. According to additional aspects of the present disclosure, a gaming terminal can be configured to monitor a player's beverage within an alcove and facilitate an offer of a refill or an additional beverage.

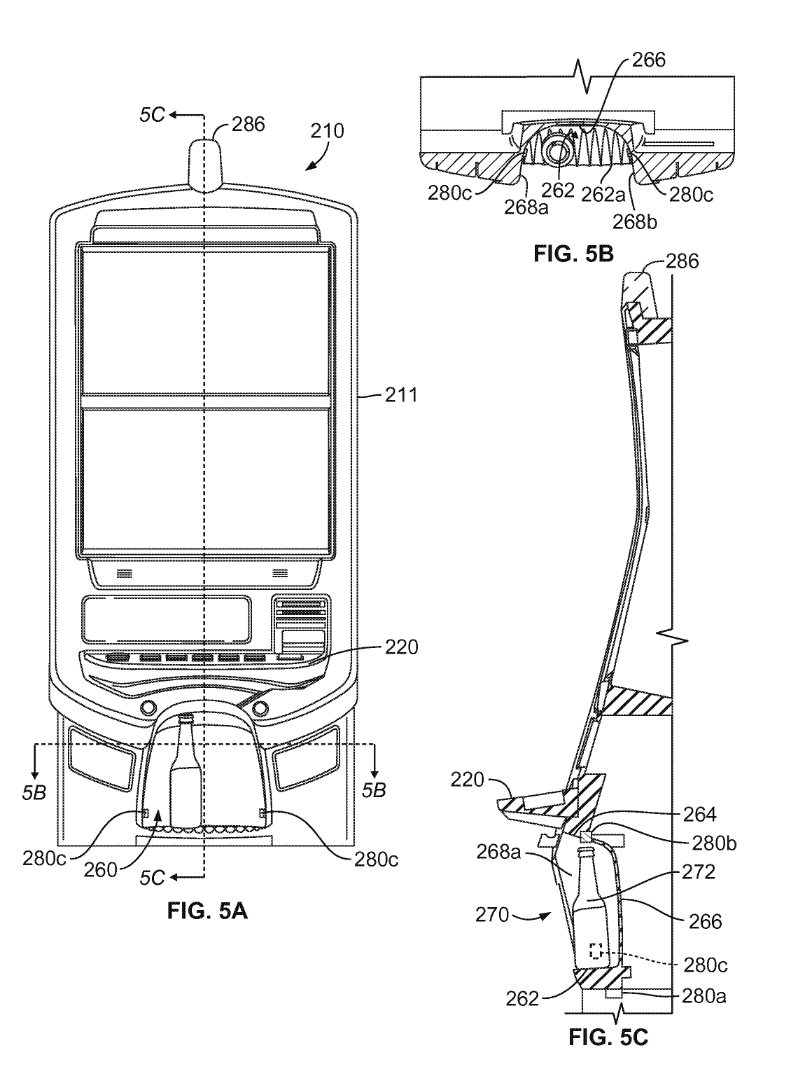

Referring now to FIGS. 5A-5C, an exemplary gaming terminal 210 according to these additional aspects of the present disclosure is illustrated. The gaming terminal 210 can include features similar to the features described above with respect to the gaming terminal 10 and/or the gaming terminal 110 and illustrated in FIGS. 1-2 and 4A-4D. For example, the gaming terminal 210 can include a cabinet 211, a primary display 212, a secondary display 214, one or more audio speakers 216, a touch screen(s) 218, a button panel(s) 220 including one or more buttons, a bill validator(s) 222, an information reader/writer(s) 224, and/or a player-accessible port(s). Additionally, the gaming terminal 210 can include an alcove 260 having a bottom surface 262, a top surface 264, a back surface 266, a first side surface 268a, a second side surface 268b, and an opening 270.

As shown, for example, in FIG. 5B, the gaming terminal 210 further includes one or more sensors 280a-c configured to measure an amount of a contents (e.g., liquid, ice, fruit, garnishes, straws, etc.) within a beverage container 272 located within the alcove 260. The one or more sensors 280a-c can be disposed within (e.g., embedded in), coupled to, and/or located near the various structures of the alcove 260 to measure the amount of the contents within the beverage container 272. In the exemplary embodiment illustrated in FIGS. 5A-5C, a first sensor 280a is coupled to the bottom surface 262, a second sensor 280b is located at the top surface 264 of the alcove 260, and a third sensor 280c is located in the first side surface 268a and the second side surface 268b; however, it should be understood that a sensor can be disposed within, coupled to, and/or located near any other feature of the alcove 260. It should also be understood that while the embodiment illustrated in FIGS. 5A-5C includes three sensors 280a-c, any other number of sensor(s) can be provided.

The one or more sensors 280a-c can include any device suitable for obtaining a measured value that can be used to determine an amount of the contents within a beverage container 272 located within the alcove 260 and generating a measurement signal indicative of the measured value. For example, the one or more sensors 280a-c can include a weight sensor (e.g., a spring scale, a hydraulic scale, a pneumatic scale, a deflection sensor, etc.), an optical sensor (e.g., an image capture device, a laser rangefinder device, a light transmitter and a light receiver), an acoustic distance sensor, combinations thereof, and/or the like. In one exemplary implementation illustrated in FIGS. 5A-5C, the first sensor 280a can include a weight sensor that measures a weight of the beverage container 272 (and the contents thereof) located on the bottom surface 262 of the alcove 260. In the exemplary implementation, the second sensor 280b can include an optical sensor that measures a distance from the second sensor to the contents of the beverage container 272. Also, in the exemplary implementation, the third sensor 280c can include a light receiver located on the first side surface 268a configured to receive light emitted by a light transmitter (e.g., a laser) located on the second side surface 268b in alignment with the light receiver. The third sensor 280c can thus generate a measurement signal indicating whether or not the light emitted by the light transmitter passed through the contents of the beverage container 272 prior to being received by the light receiver.

It should be understood that the described first, second and third sensors 280a-c are examples of how the one or more sensors can detect the amount of the contents within the beverage container 272 by measuring a weight, distance, and/or position of the contents within the beverage container 272. Additionally, as described above, it should be understood that other sensors can be utilized such as, for example, a sensor that captures an image of the contents within the beverage container 272. Also, while the beverage container 272 is illustrated as a beer bottle, it should be understood that the beverage container 272 can be a glass, a flask, a can, and/or any other type of beverage container.

The one or more sensors 280a-c are communicatively coupled to the CPU 30 (e.g., via wired or wireless connectivity features). The CPU 30 is configured to process the measurement signal from at least one of the one or more sensors 280a-c to determine whether and/or how to respond to the measurement signal. In other words, the CPU 30 is configured to process the measurement signal to determine whether and/or how to offer the player at the gaming terminal 210 a refill or another beverage. For example, according to some aspects, the CPU 30 can process the measurement signal from the one or more sensors 280a-c to compare the measured value to a threshold value (or a range of threshold values) and, based on the comparison, generate an alert signal that may be communicated to other features of the gaming terminal 210 and/or an external system (e.g., the external system 48) to produce a response.

According to some aspects, the threshold value can be a predetermined value in that the threshold value is determined prior to a player placing a beverage container 272 in the alcove 260 for the first time. For example, the threshold value can be based on a weight that has been predetermined as being indicative of a player potentially needing a refill or another beverage. As another example, the threshold value can be based on a distance from the second sensor 280b that has been predetermined as being indicative of a player potentially needing a refill or another beverage. As such, the CPU 30 can compare the measured value indicated by the measurement signal to a predetermined threshold value to determine whether and/or how to offer the player a refill or another beverage.

According to some aspects, the threshold value can be a dynamic value that is determined after a player places a beverage container 272 in the alcove 260 for the first time or after play of a game on the gaming terminal is initiated for the first time. For example, after the beverage container 272 is placed in the alcove 260 for the first time, at least one of the one or more sensors 280a-c can generate an initial measurement signal that is indicative of an initial amount of the contents of the beverage container 272. The CPU 30 can be configured to determine the threshold value based on the initial measurement signal received from the at least one of the one or more sensors 280a-c (e.g., the threshold value can be determined as a percentage of the initial amount). As such, the CPU 30 can compare a measured value indicated by a subsequent measurement signal to the dynamic threshold value (determined based on the initial measurement signal) to determine whether and/or or how to offer the player a refill or another beverage.

According to some aspects, a dynamic threshold value can be reset in response to the CPU 30 determining that no beverage container 272 was located in the alcove 260 for a predetermined amount of time (i.e., a beverage container 272 was removed from the alcove 260 for more than the predetermined amount of time). According to additional or alternative aspects, a dynamic threshold value can be reset or re-determined in response to the CPU 30 determining that a subsequent measurement signal is indicative of a greater amount of contents than a prior measurement signal and/or an initial measurement signal (e.g., a heavier beverage is detected in the alcove 260).

It should be understood that a threshold value can include a predetermined threshold value, a dynamic threshold value, a range of such threshold values, and/or combinations thereof. It should also be understood that a threshold value can be based on a weight, a distance, a position, an image, and/or any other information suitable for comparison with the measurements that may be obtained by the one or more sensors 280a-c and communicated to the CPU 30.

It is also contemplated that, while the CPU 30 can compare a measured value to a threshold value, the CPU 30 can additionally or alternatively process a measurement signal in any other way suitable to determine whether and/or how to offer a player a refill or another beverage. For example, the measurement signal itself can indicate whether an amount of the contents of the beverage container 272 is below a threshold amount. In the illustrated implementation, for example, the third sensor 280c can determine if the contents of the beverage container 272 are below a threshold amount based on whether the light from the light transmitter passed through the contents of the beverage container 272 prior to being received by the light receiver (e.g., based reflection, refraction, and/or other optical properties of the light). Additionally, for example, if a sensor includes an image capture device, the measurement signal can include image information and the CPU 30 can be configured to analyze image information to determine whether and/or how to respond to the measurement signal.

It is further contemplated that, according to some aspects, the CPU 30 can be configured to determine a rate of change in the amount of the contents based on a plurality of measurement signals received from the sensors 280a-c. The CPU 30 can use the determined rate of change information to determine an estimate of a time when the amount of contents of the beverage container 272 will be less than or equal to the threshold amount. According to some aspects, the CPU 30 can be configured to generate the alert signal based on the estimate.

If, in response to the processing of the measurement signal, the CPU determines that a refill and/or another beverage is to be offered to the player, the CPU can generate an alert signal. The alert signal can be communicated to one or more features of the gaming terminal 210 and/or one or more external systems (e.g., the external system 48). For example, the alert signal can be communicated to a service light 286 of the gaming terminal 210. In response to the alert signal, the service light 286 can illuminate so as to notify the personnel of the gaming establishment that the player's beverage is running low (i.e., the amount of contents is less than or equal to the threshold amount). Once notified, the personnel may the offer the player a refill or another beverage. As another example, the alert signal can be communicated to one or more external systems to notify the personnel of the gaming establishment that the player's beverage is running low. In this instance, the alert signal can also include identification information to allow casino personnel to identify the gaming terminal 210 at which the player is located. As still another example, the alert signal generated by the CPU 30 can cause the primary display 212 to prompt the player to enter an input (e.g., via the button panel 220 or the touch screen 218) to order a refill or another beverage. It is contemplated that, according to some aspects, the player can be provided with a menu including a number of selectable options for ordering a refill or an additional beverage. The CPU 30 can be configured, for example, to communicate a player input or a selected option relating to a refill or another beverage (and, in some instances, an identification information for the gaming terminal 210) to the one or more external systems to cause delivery of the refill or beverage to the player.

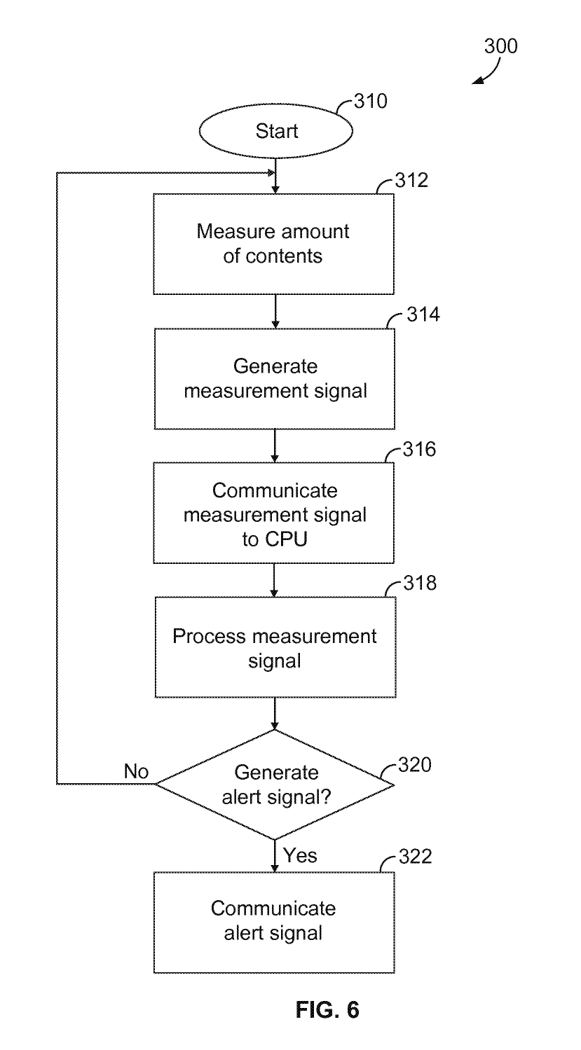

Referring now to FIG. 6, an exemplary flow chart of a process 300 for monitoring and responding to an amount of contents within a beverage container 272 located within an alcove 260 is illustrated. At block 310, the process 300 is initiated. According to some aspects, the process 300 can be initiated by a player placing a beverage container 272 within alcove 260 for the first time and/or by a player initiating play of a game on the gaming terminal 210 for the first time. At block 312, the amount of contents of the beverage container 272 is measured, for example, by at least one of the one or more sensors 280a-c. At block 314, the at least one of the one or more sensors 280a-c generates a measurement signal indicative of the measured amount of contents. At block 316, the at least one of the one or more sensors 280a-c communicates the measurement signal to the CPU 30. At block 318, the CPU 30 processes the measurement signal. At block 320, the CPU 30 determines whether to generate an alert signal based on the processing of the measurement signal at block 318. If it is determined not to generate the alert signal at block 320, the process returns to block 312. If it is determined to generate the alert signal at block 320, the CPU 30 communicates the alert signal to one or more features of the gaming terminal 210 and/or one or more external systems.

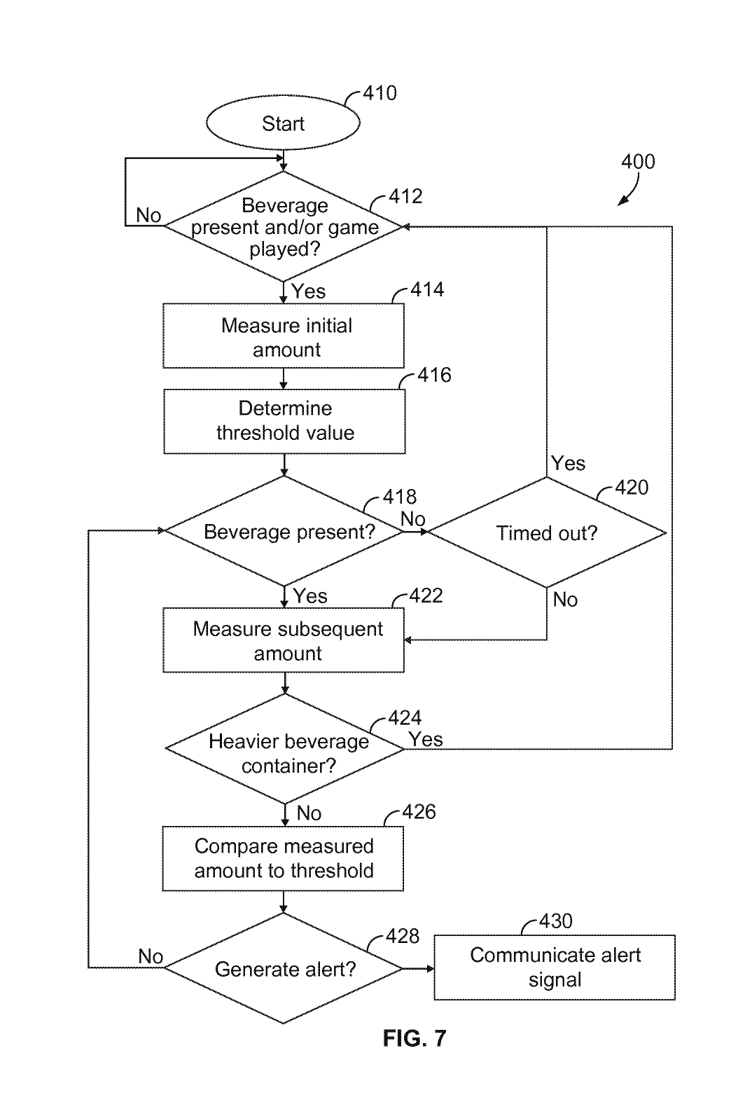

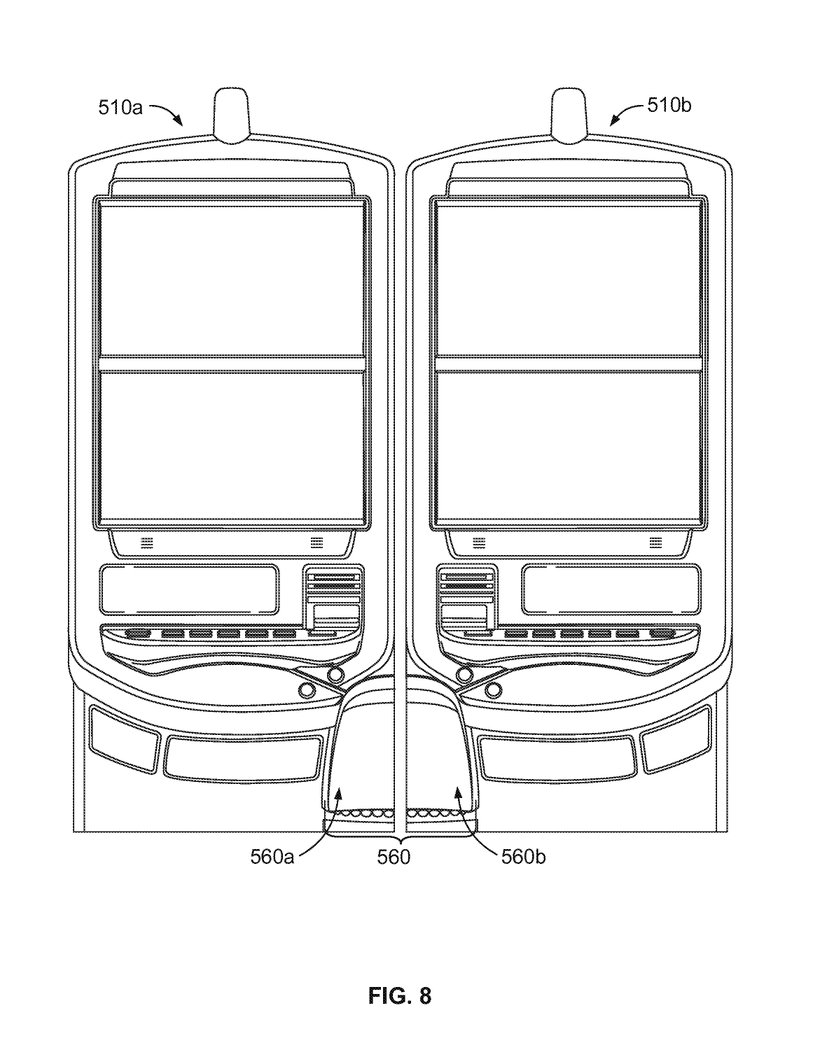

Referring now to FIG. 7, another exemplary flow chart of a process 400 for monitoring and responding to an amount of contents within a beverage container 272 located within the alcove 260 is illustrated. At block 410, the process 400 is initiated. At block 412, it is determined whether a beverage container 272 is located in the alcove 260 and/or whether a game is being played on the gaming terminal 210. If it is determined at block 412 that a beverage container 272 is not located in the alcove 260 and/or a game is not being played on the gaming terminal 210, the process 400 returns to block 410. If it is determined at block 412 that a beverage container 272 is located in the alcove 260 and/or a game is being played on the gaming terminal 210, an initial amount of contents of the beverage container 272 is measured by one or more sensors 280a-c at block 414. Also at block 414, an initial measurement signal indicative of the initial amount is generated and communicated to the CPU 30. At block 416, a threshold value is determined based on the initial measurement signal.

At block 418, it is determined whether the beverage container 272 is located in the alcove 260. If it is determined at block 418 that the beverage container 272 is not located in the alcove 260, it is determined at block 420 whether a predetermined amount of time has expired before the beverage container 272 is returned to the alcove 260. If it is determined at block 420 that the beverage container 272 is not returned to the alcove 260 before the expiration of the predetermined amount of time, the process 400 returns to block 410. If it is determined at block 420 that the beverage container 272 is returned to the alcove 260 before the expiration of the predetermined amount of time, the process 400 proceeds to block 422. At block 422, a subsequent amount of contents of the beverage container 272 is measured and a subsequent measurement signal indicative of the subsequent amount is communicated to the CPU 30. At block 424, the subsequent measurement signal is processed so as to determine whether the subsequent measurement signal is indicative of a greater amount of contents than a prior measurement signal (e.g., the initial measurement signal or a prior subsequent measurement signal). If it is determined that the subsequent measurement signal is indicative of a greater amount of contents than the prior measurement signal at block 424, the process 400 returns to block 410. If it is determined at block 424 that the subsequent measurement signal is not indicative of a greater amount of contents than the prior measurement signal, the subsequent measurement signal is processed so as to compare the subsequent measurement with the threshold value at block 426. At block 428, it is determined whether to generate an alert signal based on the comparison at block 426. If it determined at block 428 not to generate an alert signal, the process 400 returns to block 418. If it is determined to generate an alert signal at block 428, an alert signal is generated and communicated to one or more features of the gaming terminal 210 and/or one or more external systems at block 430.

FIGS. 6-7, described by way of example above, represent exemplary algorithms that correspond to at least some instructions executed by the CPU 30 in FIG. 2 to perform the above described functions associated with the disclosed concepts. It is also within the scope and spirit of the present concepts to omit steps, include additional steps, and/or modify the order of steps presented above.

While in the exemplary embodiments illustrated and described with respect to FIGS. 4A-5C include an alcove (e.g., the alcove 160 and the alcove 260) that is formed entirely within one gaming terminal (e.g., the gaming terminal 110 and the gaming terminal 210), it is contemplated that, according to some aspects, a gaming terminal can include a portion of an alcove such that the full alcove is formed when two gaming terminals are positioned adjacent to one another. For example, FIG. 8 shows a first gaming terminal 510A that includes a first alcove portion 560A and a second gaming terminal 510B that includes a second alcove portion 560B. The first alcove portion 560A is located on a right side of the gaming terminal 510A and the second alcove portion 560B is located on a left side of the gaming terminal 510B such that when the first gaming terminal 510A is positioned adjacent to the second gaming terminal 510B, the first alcove portion 560A and the second alcove portion 560B form the full alcove 560. The alcove 560 can thus include any and/or all of the features described above with respect to the alcove 160 and the alcove 260.

It is contemplated that, according to other aspects, a gaming terminal can include a plurality of portions of an alcove (e.g., the alcove 560). For example, the first gaming terminal 510A and the second gaming terminal 510B can include a portion of an alcove on both the left and right sides of the first gaming terminal 510A so that two full alcoves can be formed by the gaming terminal 510A positioned between two adjacent gaming terminals including corresponding portions of the alcoves.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming machine for playing a game, comprising:
one or more display devices configured to display the game;
a cabinet housing the one or more display devices; and
an alcove defined by a portion of an exterior surface of the cabinet, the alcove being configured to store one or more personal items and permit egress of a fluid from within the alcove.

2. The gaming machine according to claim 1, wherein the alcove includes a bottom surface, a top surface, a back surface and one or more side surfaces, the bottom surface, the top surface and the one or more side surfaces defining an opening on a front side of the alcove.

3. The gaming machine according to claim 2, wherein the bottom surface is downwardly angled from the back surface to the opening on the front side of the alcove.

4. The gaming machine according to claim 2, wherein the bottom surface includes a plurality of grooves.

5. The gaming machine according to claim 4, wherein the bottom surfaces includes a generally flat surface between each of the plurality of grooves.

6. The gaming machine according to claim 2, wherein the top surface is downwardly angled from the opening on the front side of the alcove to the back surface.

7. The gaming machine according to claim 2, wherein the one or more side surfaces and the back surface define a concave shape.

8. The gaming machine according to claim 2, wherein a portion of each of the one or more side surfaces extends beyond a proximal-most end of the bottom surface in a direction from the back surface generally towards the front opening of the alcove.

9. The gaming machine according to claim 2, further comprising a restraining bar extending across the opening on the front side from a first one of the one or more side walls to a second one of the one or more side walls.

10. The gaming machine according to claim 1, further comprising a button panel, the alcove being located below the button panel.

11. The gaming machine according to claim 1, wherein the alcove is substantially centered with respect to a width of the cabinet.

12. A gaming system, comprising:
one or more display devices configured to display a game;
a cabinet housing the one or more display devices; and
an alcove defined by a portion of an exterior surface of the cabinet, the alcove being configured to store one or more personal items, the alcove including a bottom surface, a top surface, a back surface and one or more side surfaces, the bottom surface, the top surface and the one or more side surfaces defining an opening on a front side of the alcove.

13. The gaming system according to claim 12, wherein the opening extends from a proximal-most end of the bottom surface to the top surface.

14. The gaming system according to claim 12, wherein the opening extends from a proximal-most end of the bottom surface to a restraining structure and from the restraining structure to the top surface.

15. The gaming system according to claim 12, wherein the alcove includes one side surface, the alcove being located at a lateral side of the cabinet such that the alcove can be aligned with a corresponding alcove of a different cabinet positioned adjacently to the cabinet.

16. The gaming system according to claim 12, further comprising:
one or more sensors configured to measure an amount of a contents in a beverage container stored in the alcove and generate a signal indicative of the amount of the contents; and
one or more processors in communication with the one or more sensors, the one or more processors being operable to:
receive the signal from the one or more sensors;
determine whether the measured amount of contents is below a threshold amount; and
if it is determined that the measured amount is below the threshold amount, generate an alert signal indicating that the measured amount is below the threshold amount.

17. The gaming system according to claim 16, wherein the one or more sensors include at least one of a weight sensor, an optical sensor, and an acoustic sensor.

18. The gaming system according to claim 16, further comprising a service light in communication with the one or more processors, the service light being configured to illuminate upon receipt of the alert signal to indicate that the measured amount is below the threshold amount.

19. The gaming system according to claim 16, wherein the one or more display devices are configured to prompt a player to request a service relating to the amount of contents in the beverage container in response to the alert signal.

20. The gaming system according to claim 16, further comprising an external system in communication with the one or more processors, the external system being configured to receive the alert signal, the alert signal including an indication relating to the identity of the cabinet.
